(19) United States
(12) Patent Application Publication
(10) Pub. No.: US 2026/0237701 A1
(43) Pub. Date: Aug. 13, 2026

(54) FUEL CELL CONTROL DEVICE

(71) Applicant: KABUSHIKI KAISHA TOYOTA CHUO KENKYUSHO, Nagakute-shi, Aichi-ken (JP)

(72) Inventors: Norihiro FUKAYA, Nagakute-shi (JP); Takao WATANABE, Nagakute-shi (JP)

(73) Assignee: KABUSHIKI KAISHA TOYOTA CHUO KENKYUSHO, Nagakute-shi, Aichi-ken (JP)

(21) Appl. No.: 19/160,356

(22) PCT Filed: Oct. 30, 2023
(86) PCT No.: PCT/JP2023/039011

§ 371 Date: Aug. 27, 2025

(30) Foreign Application Priority Data
Apr. 6, 2023 (JP) 2023-062351

(51) Int. Cl. H01M 8/04992; H01M 8/04537; H01M 8/04664; H01M 8/04858; H01M 8/10

(52) U.S. Cl. CPC H01M 8/04992; H01M 8/04604; H01M 8/04664; H01M 8/04865; H01M 2008/1095

(57) ABSTRACT

A fuel cell control device includes: a load demand acquisition section for acquiring a load demand P_{FC} for a polymer electrolyte fuel cell; a degradation amount estimation section for estimating an amount of degradation of a cathode catalyst contained in the polymer electrolyte fuel cell; a potential range setting section for changing a potential range Vr of the polymer electrolyte fuel cell defined by an upper limit potential V_{H} and a lower limit potential V_{L} in accordance with the amount of degradation; and a potential control section for controlling a potential of the polymer electrolyte fuel cell so that a real potential Vᵣₑₐₗ of the polymer electrolyte fuel cell corresponding to the P_{FC} is within the Vr.

### FIELD OF THE INVENTION

The present invention relates to a fuel cell control device, and more specifically, to a fuel cell control device that can suppress the degradation of a cathode catalyst to a minimum without sacrificing power density or power generation efficiency when there is a load demand on a fuel cell.

### BACKGROUND OF THE INVENTION

A polymer electrolyte fuel cell includes a membrane electrode assembly (MEA), in which catalyst layers containing a catalyst are joined to both sides of an electrolyte membrane. The catalyst layer is a portion that serves as a reaction field for electrode reactions and generally consists of a composite of carbon carrying catalyst particles such as platinum and a solid polymer electrolyte (catalyst layer ionomer).

For a polymer electrolyte fuel cell, a gas diffusion layer is usually arranged on the outside of the catalyst layer. A current collector (separator) including a gas flow path is further arranged on the outside of the gas diffusion layer. The polymer electrolyte fuel cell usually includes a structure in which a plurality of unit cells consisting of such an MEA, a gas diffusion layer and a current collector are stacked (fuel cell stack).

When a polymer electrolyte fuel cell is used as an onboard power source, the voltage of the polymer electrolyte fuel cell significantly fluctuates depending on the driving conditions of a vehicle. Although power generation efficiency is high when the polymer electrolyte fuel cell is under low load states, catalyst components are more susceptible to elution from a cathode catalyst since the cathode catalyst is exposed to a high potential state. On the other hand, although the power generation efficiency is low when the polymer electrolyte fuel cell is under high load states, eluted catalyst components are more susceptible to re-precipitation on a surface of the cathode catalyst since the cathode catalyst is exposed to a low potential state. Therefore, when the cathode catalyst is repeatedly exposed to high and low potential states, there is a problem that the cathode catalyst gradually deteriorates.

To solve this problem, various proposals have been made to date.

For example, Patent Literature 1 discloses a fuel cell system in which a fuel cell generates power so that an upper limit potential becomes an output voltage of the fuel cell instead of the output voltage at an operation point when the output voltage at the operation point of the fuel cell is determined to exceed the upper limit voltage value.

Patent Literature 2 discloses a fuel cell system that sets a current to be drawn from a fuel cell stack so that a voltage of the fuel cell stack is equal to or lower than a predetermined voltage when the idle stop state is terminated to shift the fuel cell system to a low-load idle state.

Patent Literature 3 discloses a control device for a fuel cell system that limits the output voltage of a fuel cell to a predetermined upper limit value or lower when an oxidant gas is determined to be present in an oxidant electrode upon startup of the fuel cell.

Patent Literature 4 discloses a fuel cell system including control means that controls the output voltage of a fuel cell so that a high potential is avoided by using a high potential avoidance voltage lower than its open-circuit voltage as an upper limit.

Patent Literature 5 discloses a fuel cell system in which oxidant gas supply means is operated so that a maximum cell voltage of a fuel cell is equal to or lower than a predetermined upper limit voltage during the idle stop state of the fuel cell system.

Patent Literature 6 discloses a fuel cell system that prevents a total voltage of a fuel cell from reaching or exceeding a predetermined high potential avoidance voltage threshold value by maintaining a converter command voltage at a high potential avoidance voltage lower than an open-circuit voltage of the fuel cell.

Patent Literature 7 discloses a power generation amount control device for a fuel cell in which the smaller of an output of output upper limit value calculation means or an output of target power generation amount calculation means is set as a command value of an output to be drawn from the fuel cell.

Patent Literature 8 discloses a fuel cell system that determines a predicted state of degradation of an electrode catalyst layer in a fuel cell and determines an upper limit value for the output voltage of the fuel cell in accordance with the determined state of degradation.

Patent Literature 9 discloses a fuel cell system including control means for controlling operation of the output voltage of a fuel cell with a high potential avoidance voltage lower than its open-circuit voltage as an upper limit, and high potential avoidance voltage setting means for variably setting the high potential avoidance voltage in accordance with a state of charge of an energy storage unit.

Furthermore, Patent Literature 10 discloses a fuel cell system including:
a fuel cell that generates power by being supplied with a reaction gas;
an energy storage unit that charges at least part of the electricity generated by the fuel cell; and
a control section that controls a lower limit potential of the fuel cell so that an amount of charge of the energy storage unit does not exceed an upper charge threshold when the amount of charge of the energy storage unit is predicted to reach the upper charge threshold.

The degradation of a fuel cell can be suppressed to some extent by defining a range (upper limit potential and lower limit potential) over which the fuel cell is to be operated. This is also likely to improve the durability. However, in all of Patent Literatures 1 to 7, the operating range of the fuel cell is fixed, which causes a decrease in power generation efficiency or a decrease in power density of the fuel cell as a drawback.

The decrease in power generation efficiency is due to the characteristic of fuel cells that the lower the load, the higher the power generation efficiency. Setting an upper limit potential prevents the fuel cell from being used at a power generation point with high efficiency, resulting in a decrease in power generation efficiency.

The decrease in power density is due to the fact that setting a lower-limit potential leads to a limited range of power that can be swept.

On the other hand, Patent Literature 8 discloses a method of varying the upper limit potential in accordance with the state of degradation of the electrode catalyst layer. However, the method described in the Literature only serves to extend the life of the fuel cell by changing the upper limit potential in accordance with the number of fluctuations and cannot realize both high power generation efficiency and high power density.

Furthermore, the methods described in Patent Literatures 9 and 10 are methods for suppressing the degradation (overcharging) of the energy storage unit, not for suppressing the degradation of the fuel cell.

### CITATION LIST

### Patent Literature

Patent Literature 1: Japanese Unexamined Patent Application Publication No. 2012-094257
Patent Literature 2: Japanese Unexamined Patent Application Publication No. 2006-309971
Patent Literature 3: Japanese Unexamined Patent Application Publication No. 2008-165994
Patent Literature 4: Japanese Unexamined Patent Application Publication No. 2009-129639
Patent Literature 5: Japanese Unexamined Patent Application Publication No. 2007-109569
Patent Literature 6: Japanese Unexamined Patent Application Publication No. 2009-104977
Patent Literature 7: Japanese Unexamined Patent Application Publication No. 2003-036871
Patent Literature 8: Japanese Unexamined Patent Application Publication No. 2012-129069
Patent Literature 9: Japanese Unexamined Patent Application Publication No. 2009-129647
Patent Literature 10: Japanese Unexamined Patent Application Publication No. 2013-098052

### SUMMARY OF THE INVENTION

The problem to be solved by the present invention is to provide a fuel cell control device that can suppress the degradation of a cathode catalyst to a minimum without sacrificing power density or power generation efficiency when there is a load demand on a fuel cell.

To solve the problem described above, a fuel cell control device according to the present invention includes:
a load demand acquisition section for acquiring a load demand PEC for a polymer electrolyte fuel cell;
a degradation amount estimation section for estimating an amount of degradation of a cathode catalyst of the polymer electrolyte fuel cell;
a potential range setting section for changing a potential range Vr of the polymer electrolyte fuel cell defined by an upper limit potential V_{H} and a lower limit potential V_{L} in accordance with the amount of degradation; and
a potential control section for controlling a potential of the polymer electrolyte fuel cell so that a real potential Vᵣₑₐₗ of the polymer electrolyte fuel cell corresponding to the P_{FC} is within the Vr.

The degradation amount estimation section preferably includes:
an ECS estimation section for estimating an electrochemical effective surface area A_{ECS}[i] of the cathode catalyst at a time [i]; and
an average particle size estimation section for estimating an average particle size D_{CAT}[i] of the cathode catalyst at the time [i], based on the A_{ECS}[i].

The potential range setting section preferably includes:
a first setting section for increasing the V_{H} as the D_{CAT}[i] increases; and/or
a second setting section for increasing the V_{L} as the D_{CAT}[i] increases.

An equilibrium potential of an electrochemical reaction (reaction A) at which components of the cathode catalyst elute depends on the average particle size D_{CAT}[i] of the cathode catalyst. Specifically, a higher potential is required to cause reaction A as the D_{CAT}[i] increases. Thus, since reaction A is hard to proceed even with an increased potential when D_{CAT}[i] is large, a higher upper limit potential V_{H} causes a small decrease in durability. Rather, increasing the V_{H} as the D_{CAT}[i] increases causes a frequency at which the potential is maintained in a high-potential state with high efficiency to increase, thereby improving the efficiency of a fuel cell system.

On the other hand, an equilibrium potential of an electrochemical reaction (reaction B) at which oxide is formed on a surface of the cathode catalyst also depends on the D_{CAT}[i]. Specifically, a higher potential is required to cause reaction B as the D_{CAT}[i] increases. Thus, maintaining the Vi at a low value even when the D_{CAT}[i] is large is likely to reduce the oxide. In contrast, increasing the V_{L} as the D_{CAT}[i] increases is likely to retain the oxide and improve the durability of the fuel cell.

### BRIEF DESCRIPTION OF THE DRAWINGS

FIG. 1 is a result of Arcs calculations for catalyst particles with different average particle sizes and variances.

FIG. 2 is a graph showing the relationship of an output voltage V_{P} and an output power P with respect to an output current I_{P}.

FIG. 3 is a cross-sectional schematic diagram of a Pt particle on which an oxide film is formed.

FIG. 4 is a flowchart of a method of controlling a potential according to the present invention.

FIG. 5 is a graph showing a comparison of an amount of degradation and power generation efficiency of a fuel cell system in Example 1 and Comparative Example 1.

### DETAILED DESCRIPTION OF PREFERRED EMBODIMENTS

### Configuration 1

A fuel cell control device comprising:
a load demand acquisition section for acquiring a load demand P_{FC} for a polymer electrolyte fuel cell;
a degradation amount estimation section for estimating an amount of degradation of a cathode catalyst of the polymer electrolyte fuel cell;
a potential range setting section for changing a potential range Vr of the polymer electrolyte fuel cell defined by an upper limit potential V_{H} and a lower limit potential V_{L} in accordance with the amount of degradation; and
a potential control section for controlling a potential of the polymer electrolyte fuel cell so that a real potential Vᵣₑₐₗ of the polymer electrolyte fuel cell corresponding to the P_{FC} is within the Vr.

### Configuration 2

The fuel cell control device according to Configuration 1, wherein the degradation amount estimation section comprises:
an ECS estimation section for estimating an electrochemical effective surface area A_{ECS}[i] of the cathode catalyst at a time [i]; and
an average particle size estimation section for estimating an average particle size D_{CAT}[i] of the cathode catalyst at the time [i], based on the A_{ECS}[i], and
wherein the potential range setting section comprises:
a first setting section for increasing the V_{H} as the D_{CAT}[i] increases; and/or
a second setting section for increasing the V_{L} as the D_{CAT}[i] increases.

### Configuration 3

The fuel cell control device according to Configuration 2,
wherein the ECS estimation section comprises a first calculation section for calculating the A_{ECS}[i] based on Equation (1) described below.

### Configuration 4

The fuel cell control device according to Configuration 2 or 3,
wherein the ECS estimation section comprises:
an information acquisition section for sequentially acquiring at least a voltage V[i] of the polymer electrolyte fuel cell at the time [i];
a catalyst potential calculation section for calculating a catalyst potential Vcat[i] of a cathode of the polymer electrolyte fuel cell at the time [i], using at least the V[i];
a surface utilization ratio calculation section for calculating an effective surface utilization ratio θact[i] of the cathode catalyst at the time [i], using the Vcat[i]; and
a second calculation section for calculating the A_{ECS}[i] using Equation (2) and/or Equation (3) described below.

### Configuration 5

The fuel cell control device according to any one of Configurations 2 to 4,
wherein the first setting section comprises a device for setting the V_{H} based on Equation (4) described below, and
wherein the second setting section comprises a device for setting the V_{L} based on Equation (5) described below.

### Configuration 6

The fuel cell control device according to any one of Configurations 1 to 5,
wherein the potential control section comprises:
a control point setting section for obtaining a control point defined by an output current I_{P} and an output potential V_{P} corresponding to the P_{FC}; and
a potential output section that selects
(a) the V_{P} as the Vᵣₑₐₗ when the V_{P} is within the range of the Vr,
(b) the V_{H} as the Vᵣₑₐₗ when the V_{P} is higher than the V_{H}, or
(c) the V_{L} as the Vᵣₑₐₗ when the V_{P} is lower than the V_{L}.

An embodiment of the present invention will hereinafter be described in detail.

### 1. Fuel Cell Control Device

A fuel cell control device according to the present invention includes:
a load demand acquisition section for acquiring a load demand P_{FC} for a polymer electrolyte fuel cell;
a degradation amount estimation section for estimating an amount of degradation of a cathode catalyst of the polymer electrolyte fuel cell;
a potential range setting section for changing a potential range Vr of the polymer electrolyte fuel cell defined by an upper limit potential V_{H} and a lower limit potential V_{L} in accordance with the amount of degradation; and
a potential control section for controlling a potential of the polymer electrolyte fuel cell so that a real potential Vᵣₑₐₗ of the polymer electrolyte fuel cell corresponding to the P_{FC} is within the Vr.

### 1.1. Load Demand Acquisition Section

The load demand acquisition section is a device that acquires the load demand P_{FC} for the polymer electrolyte fuel cell (hereinafter also referred to as “fuel cell”). The acquired P_{FC} is stored in a memory.

The configuration of the load demand acquisition section is not particularly limited as long as it serves such a function, and an optimal configuration can be selected depending on the purpose.

The fuel cell control device according to the present invention is used to control the potential of the fuel cell in a fuel cell system including a fuel cell and a secondary battery. The total load demand Pₜₒₜₐₗ for the system is usually divided into the load demand P_{FC} for the fuel cell and the load demand P_{BAT} for the secondary battery so that the efficiency of the entire system is maximized. The P_{FC} acquired in this way is used in the potential control section to control the real potential Vᵣₑₐₗ of the fuel cell. This aspect is described later.

### 1.2. Degradation Amount Estimation Section

### 1.2.1 Summary

The degradation amount estimation section is a device that estimates the amount of degradation of the cathode catalyst of the polymer electrolyte fuel cell. The estimated amount of degradation is stored in the memory.

The configuration of the degradation amount estimation section is not particularly limited as long as it serves such a function, and an optimal configuration can be selected depending on the purpose.

A type of the “amount of degradation,” in other words, a “parameter representing the degree of degradation of the cathode catalyst,” is not particularly limited, and an optimal parameter can be selected depending on the purpose.

The degradation of the cathode catalyst is caused by an increase in the average particle size D_{CAT} of the cathode catalyst due to repeated elution and re-precipitation of catalyst components. The electrochemical effective surface area A_{ECS} of the cathode catalyst decreases as the D_{CAT} increases. Therefore, the degradation amount estimation section is preferably a device that can estimate the average particle size D_{CAT}[i] of the cathode catalyst at the time [i], and/or the electrochemical effective surface area A_{ECS}[i] of the cathode catalyst at the time [i].

Specifically, the degradation amount estimation section preferably includes:
the ECS estimation section for estimating the electrochemical effective surface area A_{ECS}[i] of the cathode catalyst at the time [i]; and
the average particle size estimation section for estimating the average particle size D_{CAT}[i] of the cathode catalyst at the time [i], based on the A_{ECS}[i].

In an actual fuel cell, it is difficult to identify the D_{CAT} directly by nondestructive testing. On the other hand, the electrochemical effective surface area Arcs of the cathode catalyst can be estimated based on an operation history or operating conditions of the fuel cell. Furthermore, the D_{CAT} has a strong correlation with the A_{ECS}. In general, the larger the D_{CAT}, the smaller the A_{ECS}. Thus, if the electrochemical effective surface area A_{ECS}[i] at the time [i] can be sequentially estimated, the average particle size D_{CAT}[i] of the cathode catalyst at the time [i] can be estimated based on the estimated A_{ECS}[i].

### [1.2.2. ECS Estimation Section: Estimation of A_{ECS}[i]]

The configuration of the ECS estimation section is not particularly limited as long as it is capable of estimating the A_{ECS}[i], and an optimal configuration can be selected depending on the purpose. Specifically, examples of ECS estimation sections include the following. The ECS estimation section may include any one or more of the following types of devices.

### [A. First Specific Example: Estimation of A_{ECS}[I] Using Accumulated Time]

The ECS estimation section may include the first calculation section for calculating the A_{ECS}[i] based on the following equation (1). The calculated A_{ECS}[i] is stored in the memory.

$$[ Math . 1 ]$$

$${A}_{ECS} [ i ] = {A}_{ECS 0} - {B}_{1} \times {\sum }_{0}^{i} {T}_{S} \qquad ( 1 )$$

where
A_{ECS0} is an initial value of the electrochemical effective surface area,
B₁ is a fitting coefficient, and
Ts is a calculation interval.

Note that the A_{ECS0} and B₁ are preferably set so that they are consistent with the results of an initial performance test and an endurance test, respectively, performed in advance on a fuel cell with the same specifications as a control target.

Equation (1) is an equation for calculating the A_{ECS}[i] using the accumulated time (=ΣTs) of power generation by the fuel cell. In general, since the number of repetitions of elution and re-precipitation of the catalyst components increases as the accumulated time of power generation by the fuel cell increases, the A_{ECS}[i] decreases monotonically with the accumulated time. Equation (1) is an approximate expression that approximates such a change in the A_{ECS}[i] by a linear function of the accumulated time. Equation (1) has the advantage of lower calculation cost, although its estimation accuracy is low.

### [B. Second Specific Example: Estimation of A_{ECS}[i] Using Voltage of Fuel Cell]

The ECS estimation section may include:

the information acquisition section for sequentially acquiring at least the voltage V[i] of the polymer electrolyte fuel cell at the time [i];
the catalyst potential calculation section for calculating the catalyst potential Vcat[i] of the cathode of the polymer electrolyte fuel cell at the time [i], using at least the V[i];
the surface utilization ratio calculation section for calculating the effective surface utilization ratio θact[i] of the cathode catalyst at the time [i], using the Vcat[i]; and
the second calculation section for calculating the A_{ECS}[i] using Equation (2) and/or Equation (3) described below.

### B.1. Information Acquisition Section

The information acquisition section is a device for acquiring information necessary for calculating the θact[i] and the Vcat[i]. The acquired information is stored in a memory. The configuration of the information acquisition section is not particularly limited as long as it serves such a function, and an optimal configuration can be selected depending on the purpose.

To calculate the θact[i] and the Vcat[i], the information acquisition section needs to be capable of sequentially acquiring at least the voltage V[i] of the fuel cell. The information acquisition section may be capable of sequentially acquiring other information in addition to the V[i]. If the information acquisition section is capable of acquiring other information, the calculation accuracy of the θact[i] and the Vcat[i] may be even higher.

Examples of other information include a current I[i], a high-frequency impedance R [i], a temperature T_{FC}[i], the humidity RH [i] of the cathode or an anode, a gas flow rate Q [i] of the cathode or the anode, and a gas pressure Pr[i] of the cathode or the anode of the fuel cell at the time [i].

### B.2. Catalyst Potential Calculation Section

The catalyst potential calculation section is a device that calculates the catalyst potential Vcat[i] of the cathode of the polymer electrolyte fuel cell at the time [i], using at least the V[i]. The calculated Vcat[i] is stored in the memory. The configuration of the catalyst potential calculation section is not particularly limited as long as it serves such a function, and an optimal configuration can be selected depending on the purpose. The details of a method for calculating the Vcat[i] are described later.

### B.3. Surface Utilization Ratio Calculation Section

The surface utilization ratio calculation section is a device that calculates the effective surface utilization ratio θact[i] of the cathode catalyst at the time [i], using the Vcat[i]. The calculated θcat[i] is stored in the memory. The configuration of the surface utilization ratio calculation section is not particularly limited as long as it serves such a function, and an optimal configuration can be selected depending on the purpose. The details of a method for calculating the θcat[i] are described later.

### B.4. Second Calculation Section

The second calculation section is a device that calculates the A_{ECS}[i] using the following equation (2) and/or equation (3). The calculated A_{ECS}[i] is stored in the memory. The configuration of the second calculation section is not particularly limited as long as it serves such a function, and an optimal configuration can be selected depending on the purpose.

$$[ Math . 2 ]$$

$${A}_{ECS} [ i ] = {A}_{ECS 0} - {\sum }_{0}^{i} \{ {T}_{S} \times {θ}_{act} [ i ] \times exp ( {D}_{1} \times ( {D}_{2} - {V}_{cat} [ i ] ) ) \} \qquad ( 2 )$$

$${A}_{ECS} [ i ] = {A}_{ECS 0} - {\sum }_{0}^{i} \{ {T}_{S} \times {θ}_{act} [ i ] \times exp ( {D}_{1} \times ( {D}_{2} - V [ i ] ) ) \} \qquad ( 3 )$$

where
A_{ECS0} is the initial value of the electrochemical effective surface area,
D₁ to D₄ are the fitting coefficients, and
Ts is the calculation interval.

Note that the A_{ECS0} and D₁ to D₄ are preferably set so that they are consistent with the results of an initial performance test and an endurance test, respectively, performed in advance on a fuel cell with the same specifications as a control target.

Equation (2) is an equation for calculating the A_{ESC}[i] using Ts, the θact[i] and the Vcat[i]. Equation (2) calculates the A_{ECS}[i] more rigorously than Equation (1). Although Equation (1) calculates the A_{ECS}[i] assuming that the catalyst components dissolve and precipitate regardless of the Vcat[i], the A_{ECS}[i] should inherently depend on the Vcat[i].

Equation (2) focuses on a phenomenon during elution and assumes that an amount of the elution is proportional to an exponential function with base e and exponent Vcat[i]. It is also assumed that the catalyst components elute only in the region that is not covered with oxide, with the exponential function described above multiplied by the θact[i]. However, Equation (2) has the disadvantage of high calculation cost compared to Equation (1).

Equation (3) is an equation for calculating the A_{ESC}[i] using the Ts, the θact[i] and the V[i]. In Equation (3), the V[i] is used instead of the Vcat[i]. As a result, Equation (3) is slightly less accurate than Equation (2).

### C. Other Specific Examples

The A_{ECS}[i] may also be calculated using the degradation prediction method described in the following cited reference 1. Alternatively, physical models for calculating the A_{ECS}[i] are also reported in the following cited references 2 and 3.
[Cited Reference 1] Japanese Unexamined Patent Application Publication No. 2010-236989
[Cited Reference 2] Darling, R. M. and J. P. Meyers (2003), “Kinetic model of platinum dissolution in PEMFCs,” Journal of the Electrochemical Society 150 (11): A1523-A1527
[Cited Reference 3] Sekine, S. (2020), “PtCo Catalyst Dissolution and Oxidation Modeling for Durability Improvement of Automotive Fuel Cell,” ECS transaction

### [1.2.3. Average Particle Size Estimation Section: Estimation of D_{CAT}[i]]

The average particle size estimation section is a device that estimates the average particle size D_{CAT}[i] of the cathode catalyst at the time [i], based on the A_{ECS}[i]. The estimated D_{CAT}[i] is stored in the memory. The configuration of the average particle size estimation section is not particularly limited as long as it serves such a function, and an optimal configuration can be selected depending on the purpose.

For example, assuming that
(a) a shape of catalyst particles is a perfect sphere,
(b) a particle size distribution of the catalyst particles follows a semi-log-normal distribution, and
(c) a variance σ² of the particle size does not change when the average particle size of the catalyst particles changes,
the A_{ECS} of the catalyst particles with different average particle sizes and variances can be calculated by theoretical calculations.

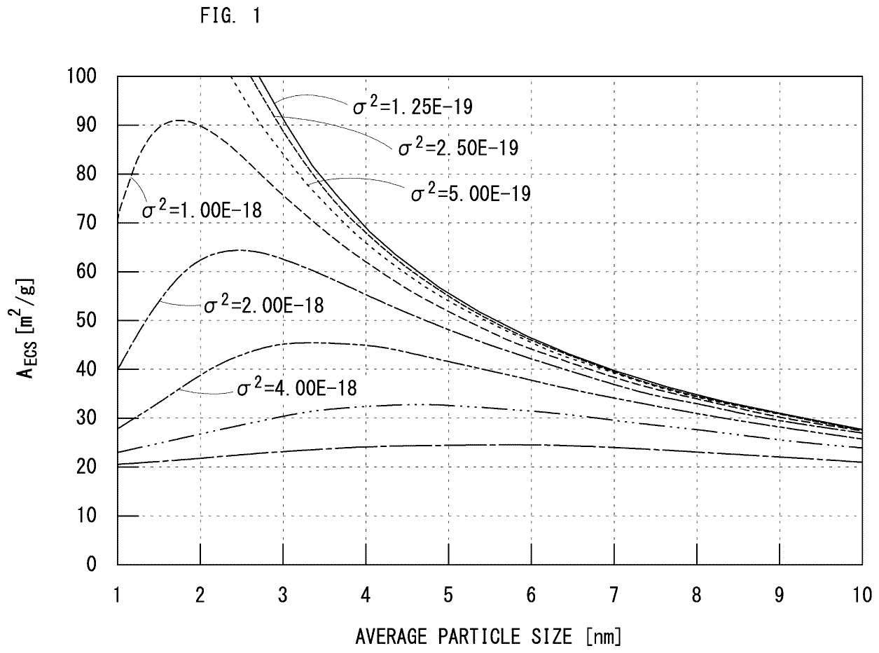

FIG. 1 shows a result of the A_{ECS} calculations for catalyst particles with different average particle sizes and variances. An initial variance σ² of the cathode catalyst used in the fuel cell is known. Thus, assuming that the σ² does not change even when the average particle size changes, an estimated value of the A_{ECS}[i] gives the D_{CAT}[i] corresponding to the A_{ECS}[i] based on FIG. 1.

Note that some of the average particle size-Arcs curves are convex upward in FIG. 1. Thus, for example, if the initial variance σ² is 2.0×10⁻¹⁸ [m²] and the A_{ECS}[i] is 50 [m²/g], two values (approximately 1.3 nm and 4.6 nm) will be possible as the average particle size that satisfies this condition. In such a case, the larger value (approximately 4.6 nm) is to be adopted as the D_{CAT}[i]. This is because it is very difficult to actually prepare catalyst particles that satisfy the smaller value (approximately 1.3 nm).

### 1.3. Potential Range Setting Section

The potential range setting section is a device that changes the potential range Vr of the polymer electrolyte fuel cell defined by the upper limit potential V_{H} and the lower limit potential V_{L} in accordance with the amount of degradation. The changed Vr is stored in the memory. The configuration of the potential range setting section is not particularly limited as long as it serves such a function, and an optimal configuration can be selected depending on the purpose.

To suppress the degradation of the cathode catalyst, the potential range setting section preferably includes:
the first setting section for increasing the V_{H} as the D_{CAT}[i] increases; and/or
the second setting section for increasing the V_{L} as the D_{CAT}[i] increases.

Note that “increasing the V_{H} (or the V_{L}) as the D_{CAT}[i] increases” also implies “decreasing the V_{H} (or the V_{L}) as the D_{CAT}[i] decreases.”

As the cathode catalyst degrades, the D_{CAT}[i] becomes larger than an average particle size D_{CAT}[i−1] of the cathode catalyst at a time [i−1]. Thus, only a process that increases the V_{H} and/or the V_{L} is usually performed.

Note, however, that the D_{CAT}[i] may become smaller than the D_{CAT}[i−1] when, for example, the fuel cell is replaced with a new one with the same specifications or with a fuel cell with different specifications. In such a case, the V_{H} and/or the V_{L} may decrease as the D_{CAT}[i] becomes smaller.

The V_{H} affects the chemical reaction (reaction A) that causes the elution of the components of the cathode catalyst. An equilibrium potential of reaction A increases as the D_{CAT}[i] increases. Thus, when the D_{CAT}[i] is large, increasing the V_{H} makes reaction A hard to proceed. Rather, increasing the V_{H} as the D_{CAT}[i] increases causes a frequency at which the potential is maintained in a high-potential state with high efficiency to increase, thereby improving the efficiency of the fuel cell system.

The V_{L} affects the reaction (reaction B) in which oxide is formed on a surface of the cathode catalyst. An equilibrium potential of reaction B also increases as the D_{CAT}[i] increases. Thus, maintaining the V_{L} at a low value even when the D_{CAT}[i] is large is likely to reduce the oxide. In contrast, increasing the V_{L} as the D_{CAT}[i] increases is likely to retain the oxide and improve the durability of the fuel cell.

The first setting section and the second setting section are not particularly limited as long as they serve such a function. The first setting section preferably includes a device that sets the V_{H} based on the following equation (4). Similarly, the second setting section preferably includes a device that sets the V_{L} based on the following equation (5).

$$[ Math . 3 ]$$

$${V}_{H} = {β}_{1} + \frac{{β}_{2}}{{D}_{CAT} [ i ]} \qquad ( 4 )$$

$${V}_{L} = {β}_{3} + \frac{{β}_{4}}{{D}_{CAT} [ i ]} \qquad ( 5 )$$

where β₁ to β₄ are fitting coefficients.

Equations (4) and (5) are empirical expressions for the relationship between the D_{CAT}[i] and the V_{H}, and the D_{CAT}[i] and the V_{L}, respectively. Equations (4) and (5) have the advantage of low calculation load since they are approximate expressions that approximate the V_{H} or the V_{L} by a linear function of (1/D_{CAT}[i]).

The β₁ to β₄ are defined based on the requirements for the durability of the fuel cell system. Optimizing signs and absolute values of the β₁ to β₄ allows the Vr to be set so that the V_{H} and/or the V_{L} increase as the D_{CAT}[i] increases.

### 1.4. Potential Control Section

The potential control section is a device that controls the potential of the polymer electrolyte fuel cell so that the real potential Vᵣₑₐₗ of the polymer electrolyte fuel cell corresponding to the P_{FC} is within the Vr. The configuration of the potential control section is not particularly limited as long as it serves such a function, and an optimal configuration can be selected depending on the purpose. The potential control section preferably includes the control point setting section and the potential output section in particular.

### 1.4.1. Control Point Setting Section

The control point setting section is a device that obtains the control point defined by the output current I_{P} and the output potential V_{P} corresponding to the P_{FC}. The acquired V_{P} is stored in a memory. The acquired I_{P} is stored in the memory as required. The configuration of the control point setting section is not particularly limited as long as it serves such a function, and an optimal configuration can be selected depending on the purpose.

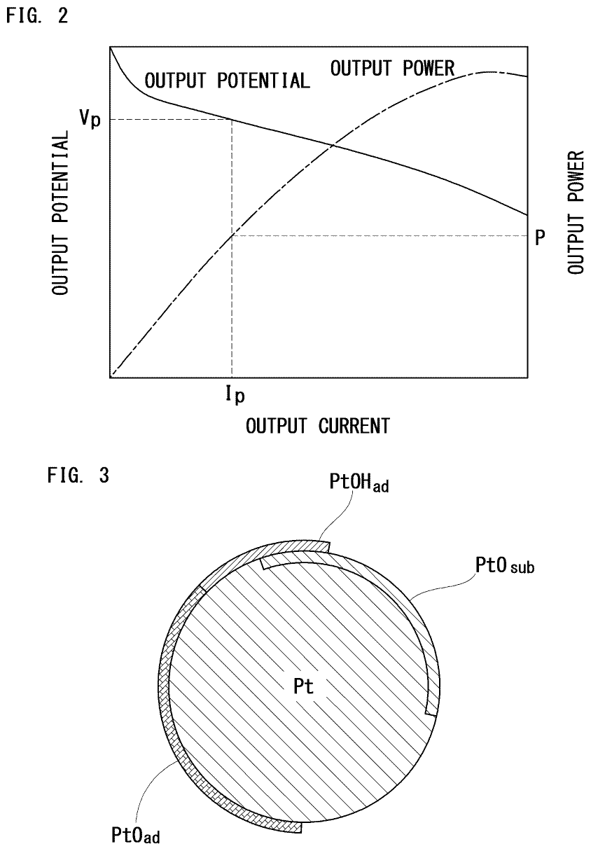

FIG. 2 shows a graph showing the relationship of an output voltage I_{P} and an output power P with respect to an output current I_{P}. The fuel cell generally exhibits an I-V characteristic as shown in FIG. 2. P is equal to the product of the I_{P} and the V_{P}. Thus, once the load demand P_{FC} is determined, the V_{P} and the I_{P} that fulfill it are uniquely determined.

### 1.4.2. Potential Output Section

The potential output section is a device that selects:
(a) the V_{P} as the Vᵣₑₐₗ when the V_{P} is within the range of the Vr;
(b) the V_{H} as the Vᵣₑₐₗ when the V_{P} is higher than the V_{H}; or
(c) the V_{L} as the Vᵣₑₐₗ when the V_{P} is lower than the V_{L}.

The configuration of the potential output section is not particularly limited as long as it serves such a function, and an optimal configuration can be selected depending on the purpose.

Once the Vᵣₑₐₗ is selected, the operation conditions of the fuel cell are controlled so that the potential of the fuel cell is equal to the selected Vᵣₑₐₗ. As a result, the degradation of the cathode catalyst can be suppressed to a minimum without sacrificing power density or power generation efficiency.

Note that if the V_{P} is not selected as the Vᵣₑₐₗ, a real output Pᵣₑₐₗ of the fuel cell will be too large or too small with respect to the P_{FC}. In such a case, the difference between the Pᵣₑₐₗ and the P_{FC} is compensated for by the charging or discharging of the secondary battery.

### [2. Method for Calculating Vcat[i]]

To accurately calculate the A_{ECS}[i], the catalyst potential Vcat[i] needs to be identified. Specifically, the Vcat[i] can be calculated by the following equation (6) or equation (7). In the present invention, either method may be used.

$$[ Math . 4 ]$$

$${V}_{cat} [ i ] = \frac{V [ i ]}{{N}_{cell}} \qquad ( 6 )$$

$${V}_{cat} [ i ] = \frac{V [ i ]}{{N}_{cell}} + ( \frac{I [ i ]}{{A}_{cell}} \times \frac{R [ i ] \times {A}_{cell}}{{N}_{cell}} ) \qquad ( 7 )$$

where
N_{cell} is the number of stacked cells of the polymer electrolyte fuel cell,
A_{cell} is the area of the cell,
I[i] is the current of the polymer electrolyte fuel cell at the time [i], and
R[i] is the high-frequency impedance of the polymer electrolyte fuel cell at the time [i].

The Vcat[i] expressed in Equation (6) is an approximate expression for the Vcat[i], ignoring potential drop due to internal resistance. Equation (6) is less accurate in calculation than Equation (7). However, Equation (6) can be used to calculate the Vcat[i] without using the I[i] and the R [i], thus simplifying the calculation of the Vcat[i].

The Vcat[i] is rigorously expressed by Equation (7). In Equation (7), the first term on the right side represents a potential difference between the both ends of a unit cell (cell voltage). In the first term on the right side, a potential per cell is calculated by dividing the V[i] by the N_{cell}. The second term on the right side represents the potential drop due to internal resistance per unit cell. In the second term on the right side, the I[i] and the R[i] are converted to a value per area and per cell, respectively. Equation (7) can be used to accurately calculate the Vcat[i]. To accurately calculate the A_{ECS}[i], Equation (7) is preferably used to calculate the Vcat[i].

### [3. Method for Calculating θCat[i]]

The “effective surface utilization ratio θact[i] of the cathode catalyst” is the ratio of the area of a surface (in other words, a surface not covered with an oxide film) utilized for oxygen reduction reaction (ORR) to the surface area of the cathode catalyst (noble metal-based catalyst particles).

To calculate the A_{ECS}[i], the effective surface utilization ratio θact[i] needs to be identified. Specifically, the θact[i] can be calculated as follows.

### 3.1. Noble Metal-Based Catalyst Particles

In the present invention, “cathode catalyst” refers to noble metal-based catalyst particles that consist of metal or alloy containing a noble metal element (hereinafter simply referred to as “catalyst particles”), which are active in oxygen reduction reaction (ORR). In the present invention, the materials of the catalyst particles are not particularly limited as long as they exhibit ORR activity. Examples of materials for the catalyst particles include:
(a) a noble metal (Au, Ag, Pt, Pd, Rh, Ir, Ru, Os),
(b) an alloy containing two or more noble metal elements, and
(c) an alloy containing one or more noble metal elements and one or more base metal elements (for example, Fe, Co, Ni, Cr, V and Ti).

### 3.3. Type of Oxide

When the catalyst particles are exposed to high potential, the catalyst components are more susceptible to elution from the catalyst particles. On the other hand, when the catalyst particles are exposed to high potential, an oxide film (including hydroxide) is formed on the surface of the catalyst particles, which suppresses the elution of the catalyst components from the catalyst particles. However, since the formation speed of the oxide film is low, a sudden change in cathode potential delays the formation of the oxide film, causing the catalyst components to be susceptible to elution from the catalyst particles. This means that when the fuel cell keeps being used in an environment with repeated sharp potential fluctuations, the catalyst particles will eventually degrade.

In other words, the durability of the cathode catalyst depends on the total amount of noble metal oxides and noble metal hydroxides that exist on the surface of the catalyst particles.

Meanwhile, the surfaces of the catalyst particles that are covered with the oxide film are less active in ORR than the surfaces that are not covered with the oxide film. As a result, the IV characteristic of the polymer electrolyte fuel cell depends on the θact[i] of the catalyst particles.

Noble metal oxides that exist on the surface of the catalyst particles are roughly classified into:
(a) a noble metal hydroxide adsorbed on the surface of the catalyst particles;
(b) a noble metal oxide A adsorbed on the surface of the catalyst particles; and
(c) a noble metal oxide B formed just below the surface of the particles due to oxygen diffusion into the interior of the catalyst particles.

FIG. 3 shows a cross-sectional schematic diagram of a Pt particle on which an oxide film is formed. When the Pt particle is exposed to a high potential, oxides (including hydroxides) are formed on the surface of the Pt particle.

In this case, the oxides on the surface of the Pt particle consist of:
(a) a Pt hydroxide (PtOH_{ad}) adsorbed on the surface of the Pt particle;
(b) a Pt oxide (PtO_{ad}) adsorbed on the surface of the Pt particle; and
(c) a Pt oxide (PtO_{sub}) formed in the interior just below the surface of the Pt particle due to oxygen diffusion into the interior of the Pt particle.

Here, coverage of the noble metal hydroxide adsorbed on the surface of the catalyst particles such as the PtOH_{ad} at the time [i] is denoted by θox1[i]. The θox1[i] is expressed as the ratio (=S₁/S₀) of the area (S₁) of the noble metal hydroxide adsorbed on the surface of the catalyst particle to the surface area (S₀) of the catalyst particle.

Similarly, coverage of the noble metal oxide A adsorbed on the surface of the catalyst particles such as the PtO_{ad} at the time [i] is denoted by θox2[i]. The θox2[i] is expressed as the ratio (=S₂/S₀) of the area (S₂) of the noble metal oxide A adsorbed on the surface of the catalyst particle to the S₀.

Similarly, coverage of the noble metal oxide B present inside the catalyst particles such as the PtO_{sub} at the time [i] is denoted by θox3[i]. The θox3[i] is expressed as the ratio (=S₃/S₀) of the area (S₃) of the noble metal oxide B present inside the catalyst particles to the S₀.

Note that the PtO_{sub} may be formed just below the region where the PtOH_{ad} or the PtO_{ad} is adsorbed on the surface of the Pt particle, as shown in FIG. 3. Thus, the total coverage of the Pt particle is not always equal to the sum of the θox1[i] to the θox3[i].

The θox1[i] to the θox3[i] can be obtained by sequentially calculating them using a reaction model based on the reaction rate equation. When the θox1[i] to the θox3[i] are identified, the θact[i] can be calculated using them.

### 3.3. Reaction Model

There are various methods for calculating the θact[i]. In the present invention, the method for calculating the θact[i] is not particularly limited, and an optimal method can be used depending on the purpose. Specifically, the θact[i] can be calculated by the following equation (8) or equation (9). In the present invention, either method may be used.

$$[ Math . 5 ]$$

$${θ}_{act} ( i ) = {α}_{1} - {α}_{2} ( {θ}_{ox 1} ( i ) + {θ}_{ox 2} ( i ) ) - {α}_{3} \frac{{θ}_{ox 3} ( i )}{( {θ}_{ox 1} ( i ) + {θ}_{ox 2} ( i ) )} \qquad ( 8 )$$

$${θ}_{act} ( i ) = {α}_{1} - {α}_{2} \times {θ}_{ox 1} ( i ) - {α}_{3} \times {θ}_{ox 2} ( i ) - {α}_{4} \times {θ}_{ox 3} ( i ) \qquad ( 9 )$$

$${θ}_{ox 1} ( i ) = {θ}_{ox 1} ( i - 1 ) + {T}_{s} \times \frac{{v}_{1} - {v}_{2}}{Γ}$$

$${θ}_{ox 2} ( i ) = {θ}_{ox 2} ( i - 1 ) + {T}_{s} \times \frac{{v}_{2} - {v}_{3}}{Γ}$$

$${θ}_{ox 3} ( i ) = {θ}_{ox 3} ( i - 1 ) + {T}_{s} \times \frac{{v}_{3}}{Γ}$$

$${v}_{1} = {α}_{11} \{ ( 1 - {θ}_{ox 1} ( i - 1 ) - {θ}_{ox 2} ( i - 1 ) ) \times exp ( {α}_{12} \times {G}_{1} ) - {θ}_{ox 1} ( i - 1 ) \times exp ( - {α}_{13} \times {G}_{1} ) \}$$

$${v}_{2} = {α}_{21} \{ {θ}_{ox 1} ( i - 1 ) \times exp ( {α}_{22} \times {G}_{2} ) - {θ}_{ox 2} ( i - 1 ) \times exp ( - {α}_{23} \times {G}_{2} ) \}$$

$${v}_{3} = {α}_{31} \{ ( 1 - {θ}_{ox 3} ( i - 1 ) ) \times {θ}_{ox 2} ( i - 1 ) \times exp ( {α}_{32} \times {G}_{3} ) - {θ}_{ox 3} ( i - 1 ) \times ( 1 - {θ}_{ox 1} ( i - 1 ) - {θ}_{ox 2} ( i - 1 ) ) \times exp ( - {α}_{33} \times {G}_{3} ) \}$$

$${G}_{1} = {V}_{cat} ( ιγ - {α}_{14} - {α}_{15} \times {θ}_{ox 1} ( i - 1 ) - {α}_{16} \times {θ}_{ox 2} ( i - 1 ) - {α}_{17} \times {θ}_{ox 3} ( i - 1 )$$

$${G}_{2} = {V}_{cat} ( i ) - {α}_{24} - {α}_{25} \times {θ}_{ox 1} ( i - 1 ) - {α}_{26} \times {θ}_{ox 2} ( i - 1 ) - {α}_{27} \times {θ}_{0 x 3} ( i - 1 )$$

$${G}_{3} = {V}_{cat} ( i ) - {α}_{34} - {α}_{35} \times {θ}_{ox 1} ( i - 1 ) - {α}_{36} \times {θ}_{ox 2} ( i - 1 ) - {α}_{37} \times {θ}_{ox 3} ( i - 1 )$$

where
the θox1[i] is the coverage of the noble metal hydroxide adsorbed on the surface of the catalyst particle at the time [i],
the θox2[i] is the coverage of the noble metal oxide A adsorbed on the surface of the catalyst particle at the time [i],
the θox3[i] is the coverage of the noble metal oxide B present inside the catalyst particle at the time [i],
Γ is the maximum surface covering oxygen amount (constant) per unit surface area,
Ts is a calculation step width, and
each of α₁ to α₄, α₁₁ to α₁₇, α₂₁ to α₂₇ and α₃₁ to α₃₇ is a fitting coefficient.

Specifically, the Ts represents the time from the time [i−1] to the time [i]. The value of the Ts is not particularly limited, and an optimal value can be set depending on the purpose. The Ts is usually set in the range of 0.01 s to 100 s.

Each of the α₁ to α₃₇ is preferably determined to fit the actual IV characteristics or test results obtained by cyclic voltammetry (CV).

The v₁ to v₃ represent reaction rates of formation or disappearance of each oxide or hydroxide (MO_{ad}, MOH_{ad} and MO_{sub}).

The G₁ to G₃ represent free energies of reactions of v₁ to v₃.

Each of the θox1[i−1], θox2[i−1] and θox3[i−1] is coverage at the time [i−1] and has already been stored in the memory. The θox1[i−1], the θox2[i−1] and the θox3[i−1] can be calculated by sequentially calculating once their initial values are identified. Values at the time of previous stop may be held and used as initial values. In general, when the fuel cell is stopped, it is often retained at a low potential, and at that time, all the oxides are reduced. Thus, the initial values after the fuel cell is stopped may be set as θox1=θox2=θox3=0.

Therefore, once the Vcat[i] is acquired, the θact[i] can be calculated from Equation (8) or Equation (9).

Equation (9) calculates the θact[i] by subtracting each of the coverages multiplied by the coefficient (α₂ to α₄) from a total surface (α₁). The θox1[i] represents the coverage of hydroxide due to one-electron reactions. Each of the θox2[i] and the θox3[i] represents the coverage of oxide due to two-electron reactions. The assumption that one platinum surface site is consumed per one-electron reaction gives α₁=1, α₂=1, α₃=2 and α₄=2. Note that in actual use, the surface of platinum is not uniform, thus the α₁ to α₄ are determined to fit the test results.

However, Equation (9) does not take into account the fact that oxidizing species on the surface (the coverages θox1[i] and θox2[i]) and oxidizing species in the interior (the coverage θox3[i]) are generated at the same platinum site, and in such a case, the θact[i] may be underestimated. For example, when the state of high Vcat[i] continues, each of the increased θox1[i], θox2[i] and θox3[i] will make the problem described above more significant, thus the accuracy may decrease.

In contrast, Equation (8) has the advantage that it can estimate accurately even in the above case by taking the ratio between the oxidizing species on the surface and the oxidizing species in the interior. In other cases, however, Equation (8) may be less accurate than Equation (9).

### 4. Flowchart

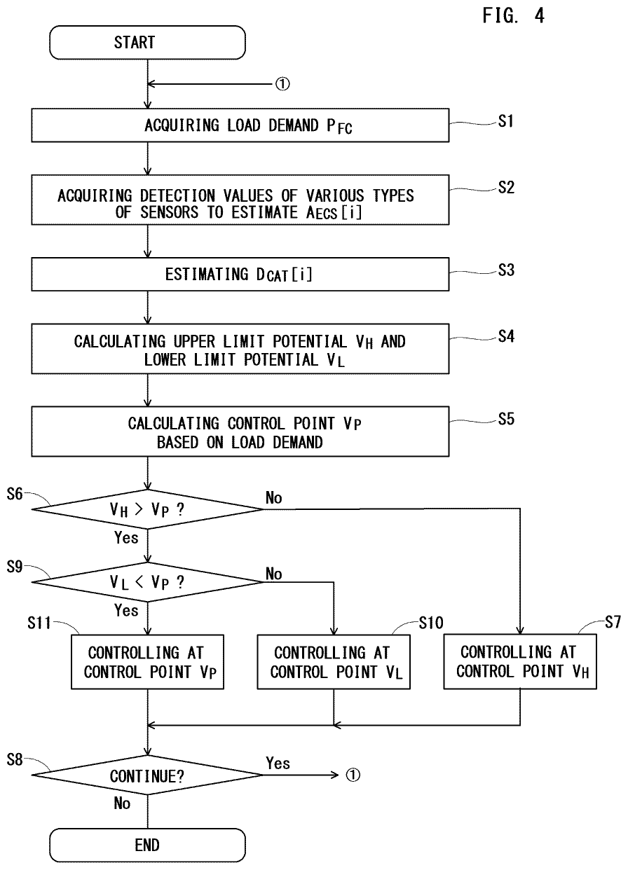

FIG. 4 shows a flowchart of a method of controlling a potential according to the present invention. First, in step 1 (hereinafter simply referred to as “S1”), the load demand P_{FC} for the fuel cell is acquired (load demand acquisition section).

Next, in S2, detection values of various types of sensors are acquired to estimate the electrochemical surface area A_{ECS}[i] of the cathode catalyst contained in the fuel cell (the degradation amount estimation section and the ECS estimation section). Examples of detection values include the voltage V[i], the current I[i] and the high-frequency impedance R[i] of the fuel cell at the time [i].

Next, in S3, the average particle size D_{CAT}[i] of the cathode catalyst at the time [i] is estimated based on the A_{ECS}[i] (the degradation amount estimation section and the average particle size estimation section).

Next, in S4, the potential range Vr of the polymer electrolyte fuel cell defined by the upper limit potential V_{H} and the lower limit potential V_{L} is changed in accordance with the amount of degradation (namely the A_{ECS}[i] and the D_{CAT}[i]) (the potential range setting section). Specifically, the setting of the Vr is preferably performed using Equation (4) and Equation (5) described above (the first setting section and the second setting section).

Next, in S5, the control point V_{P} is calculated based on the P_{FC}. Next, the flow proceeds to S6. In S6, it is determined whether the V_{P} is lower than the V_{H} or not. If the V_{P} is not lower than the V_{H} (S6: NO), the flow proceeds to S7. In S7, the fuel cell is controlled so that the Vᵣₑₐₗ is equal to the V_{H}. After that, the flow proceeds to S8. In S8, it is determined whether to keep controlling or not. If it is determined to keep controlling (S8: YES), the flow returns to S1 to repeat each of the steps from S1 to S8 described above.

Conversely, in S6, if the V_{P} is lower than the V_{H} (S6: YES), the flow proceeds to S9. In S9, it is determined whether the V_{P} is higher than the V_{L} or not. If the V_{P} is not higher than the V_{L} (S9: NO), the flow proceeds to S10. In S10, the fuel cell is controlled so that the Vᵣₑₐₗ is equal to the V_{L}. After that, the flow proceeds to S8. In S8, it is determined whether to keep controlling or not. If it is determined to keep controlling (S8: YES), the flow returns to S1 to repeat each of the steps from S1 to S10 described above.

Meanwhile, in S9, if the V_{P} is higher than the V_{L} (S9: YES), the flow proceeds to S11. In S11, the fuel cell is controlled so that the Vᵣₑₐₗ is equal to the V_{P}. After that, the flow proceeds to S8. In S8, it is determined whether to keep controlling or not. If it is determined to keep controlling (S8: YES), the flow returns to S1 to repeat each of the steps from S1 to S11 described above. Conversely, if it is determined not to keep controlling (S8: NO), it stops being controlled. In the case of FIGS. 1, S6 to S7 and S9 to S11 correspond to the potential control section.

### 5. Effects

The degradation of fuel cells is mainly caused by elution and re-precipitation of the components of the cathode catalyst. The catalyst components of the cathode catalyst elute more easily as the potential increases. On the other hand, higher potential suppresses the elution reaction due to the formation of oxides on the surface of the cathode catalyst, whereas the reaction rate of the oxide formation reaction is low. In addition, when the potential decreases, the catalyst components that eluted from fine cathode catalyst particles re-precipitate on the surface of coarse cathode catalyst particles.

Large potential fluctuations during the use of the fuel cell cause such elution and re-precipitation of the catalyst components to occur repeatedly. This also leads to a decrease in the number of the cathode catalyst particles and/or a decrease in an effective reaction area (electrochemical effective surface area A_{ECS}) due to the enlargement of the cathode catalyst particles. As a result, the performance of the fuel cell degrades.

In contrast, the equilibrium potential of the electrochemical reaction (reaction A) at which components of the cathode catalyst elute depends on the average particle size D_{CAT}[i] of the cathode catalyst. Specifically, a higher potential is required to cause reaction A as the D_{CAT}[i] increases. Thus, since reaction A is hard to proceed even with an increased potential when the D_{CAT}[i] is large, a higher upper limit potential V_{H} causes a small decrease in durability. Rather, increasing the V_{H} as the D_{CAT}[i] increases causes a frequency at which the potential is maintained in a high-potential state with high efficiency to increase, thereby improving the efficiency of the fuel cell system.

It is also important to retain the oxides on the surface of the cathode catalyst to suppress the degradation of the cathode catalyst. To achieve this, it is preferable to set the lower limit potential V_{L} and operate the fuel cell at a potential always higher than the potential at which the oxides start to reduce. On the other hand, an equilibrium potential of an electrochemical reaction (reaction B) at which oxide is formed on a surface of the cathode catalyst also depends on the D_{CAT}[i]. Specifically, a higher potential is required to cause reaction B as the D_{CAT}[i] increases. Thus, maintaining the V_{L} at a low value even when the D_{CAT}[i] is large is likely to reduce the oxide. In contrast, increasing the V_{L} as the D_{CAT}[i] increases is likely to retain the oxide and improve the durability of the fuel cell.

### EXAMPLES

### Example 1, Comparative Example 1

### 1. Test Method

The amount of degradation of the cathode catalyst and the power generation efficiency were calculated by simulation when the fuel cell system with Pt particles as the cathode catalyst was operated under a specified condition.

The simulations were performed:
(a) when the upper limit potential V_{H} of the fuel cell increases from 0.8 V to 1.0 V and the lower limit potential V_{L} increases from 0.4 V to 0.7 V in accordance with the flowchart in FIG. 4 (Example 1); and
(b) when the V_{H} is fixed at 1.0 V and the V_{L} is fixed at 0.4 V (Comparative Example 1).

The operation condition of the fuel cell was LA #4 mode, which is commonly used as a pattern for exhaust gas measurement.

The power generation efficiency was determined by the ratio between the ideal energy of hydrogen estimated from the accumulated amount of hydrogen usage that can be determined from the amount of current and the amount of work used on actual traveling.

### 2. Result

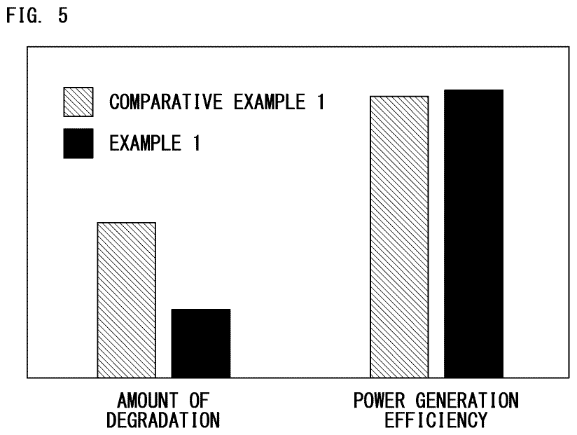

FIG. 5 shows a graph showing a comparison of an amount of degradation and power generation efficiency of the fuel cell system in Example 1 and Comparative Example 1. From FIG. 5, it can be seen that the method according to the present invention can suppress the degradation of the cathode catalyst without sacrificing the power generation efficiency.

While the above is a detailed description of the embodiment of the present invention, the present invention is not limited in any way to the above embodiment, and various modifications can be made within the scope that does not depart from the spirit of the present invention.

### INDUSTRIAL APPLICABILITY

The fuel cell potential control device according to the present invention can be used to control power generation for fuel cell vehicles.

1. A fuel cell control device comprising:
a load demand acquisition section for acquiring a load demand P_{FC} for a polymer electrolyte fuel cell;
a degradation amount estimation section for estimating an amount of degradation of a cathode catalyst of the polymer electrolyte fuel cell;
a potential range setting section for changing a potential range Vr of the polymer electrolyte fuel cell defined by an upper limit potential V_{H} and a lower limit potential V_{L} in accordance with the amount of degradation; and
a potential control section for controlling a potential of the polymer electrolyte fuel cell so that a real potential Vᵣₑₐₗ of the polymer electrolyte fuel cell corresponding to the P_{FC} is within the Vr.

2. The fuel cell control device according to claim 1,
wherein the degradation amount estimation section comprises:
an ECS estimation section for estimating an electrochemical effective surface area A_{ECS}[i] of the cathode catalyst at a time [i]; and
an average particle size estimation section for estimating an average particle size D_{CAT}[i] of the cathode catalyst at the time [i] based on the A_{ECS}[i], and
wherein the potential range setting section comprises:
a first setting section for increasing the V_{H} as the D_{CAT}[i] increases; and/or
a second setting section for increasing the V_{L} as the D_{CAT}[i] increases.

3. The fuel cell control device according to claim 2,
wherein the ECS estimation section comprises a first calculation section for calculating the A_{ECS}[i] based on the following equation (1).
$$[ Math . 1 ]$$
$${A}_{ECS} [ i ] = {A}_{ECS 0} - {B}_{1} \times {\sum }_{0}^{i} {T}_{S} \qquad ( 1 )$$
where
A_{ECS0} is an initial value of the electrochemical effective surface area,
B₁ is a fitting coefficient, and
Ts is a calculation interval.

4. The fuel cell control device according to claim 2,
wherein the ECS estimation section comprises:
an information acquisition section for sequentially acquiring at least a voltage V[i] of the polymer electrolyte fuel cell at the time [i];
a catalyst potential calculation section for calculating a catalyst potential Vcat[i] of a cathode of the polymer electrolyte fuel cell at the time [i], using at least the V[i];
a surface utilization ratio calculation section for calculating an effective surface utilization ratio θact[i] of the cathode catalyst at the time [i], using the Vcat[i]; and
a second calculation section for calculating the A_{ECS}[i] using the following equation (2) and/or equation (3).
$$[ Math . 2 ]$$
$${A}_{ECS} [ i ] = {A}_{ECS 0} - {\sum }_{0}^{i} \{ {T}_{S} \times {θ}_{act} [ i ] \times exp ( {D}_{1} \times ( {D}_{2} - {V}_{cat} [ i ] ) ) \} \qquad ( 2 )$$
$${A}_{ECS} [ i ] = {A}_{ECS 0} - {\sum }_{0}^{i} \{ {T}_{S} \times {θ}_{act} [ i ] \times exp ( {D}_{1} \times ( {D}_{2} - V [ i ] ) ) \} \qquad ( 3 )$$
where
A_{ESC0} is an initial value of the electrochemical effective surface area,
D₁ to D₄ are fitting coefficients, and
Ts is a calculation interval.

5. The fuel cell control device according to claim 2,
wherein the first setting section comprises a device for setting the V_{H} based on the following equation (4), and
wherein the second setting section comprises a device for setting the V_{L} based on the following equation (5).
$$[ Math . 3 ]$$
$${V}_{H} = {β}_{1} + \frac{{β}_{2}}{{D}_{CAT} [ i ]} \qquad ( 4 )$$
$${V}_{L} = {β}_{3} + \frac{{β}_{4}}{{D}_{CAT} [ i ]} \qquad ( 5 )$$
where β₁ to β₄ are fitting coefficients.

6. The fuel cell control device according to claim 1,
wherein the potential control section comprises:
a control point setting section for obtaining a control point defined by an output current I_{P} and an output potential V_{P} corresponding to the P_{FC}; and
a potential output section that selects
(a) the V_{P} as the Vᵣₑₐₗ when the V_{P} is within the range of the Vr,
(b) the V_{H} as the Vᵣₑₐₗ When the V_{P} is higher than the V_{H}, or
(c) the V_{L} as the Vᵣₑₐₗ when the V_{P} is lower than the V_{L}.
